(19) United States
(12) Patent Application Publication
(10) Pub. No.: US 2023/0214685 A1
(43) Pub. Date: Jul. 6, 2023

(54) COMPUTER-READABLE RECORDING MEDIUM HAVING STORED THEREIN ALTERNATE INFERENCE PROGRAM, METHOD FOR ALTERNATE INFERENCE CONTROL, AND ALTERNATE INFERENCE SYSTEM

(71) Applicant: FUJITSU LIMITED, Kawasaki-shi (JP)

(72) Inventor: Masahiro Miwa, Kawaguchi (JP)

(73) Assignee: FUJITSU LIMITED, Kawasaki-shi (JP)

(21) Appl. No.: 17/945,144

(22) Filed: Sep. 15, 2022

(30) Foreign Application Priority Data
Jan. 5, 2022 (JP) 2022-000555

(51) Int. Cl. G06N 5/04; G06V 10/74

(52) U.S. Cl. CPC G06N 5/04; G06V 10/761

(57) ABSTRACT

A computer-readable recording medium having stored therein a program for causing a computer to execute a process including: receiving first image from a mobile device that photographs the first image from a variable position; transmitting the first image to a first server that executes an inference process, based on the first model, on the first image; receiving second image being same in a pixel number and a recognition target for the inference process as the first image from a fixed device that photographs the second image from a fixed position; and when determining that two of the second images received from the fixed device continuously in time series have no difference under a state where a failure of the first server is detected, transmitting the first image to a second server that executes an inference process, based on a second model, on the second image.

### CROSS-REFERENCE TO RELATED APPLICATION

This application is based upon and claims the benefit of priority of the prior Japanese Pat ent application No. 2022-000555, filed on Jan. 5, 2022, the entire contents of which are incorporated herein by reference.

### FIELD

The embodiment discussed herein is directed to a computer-readable recording medium having stored therein an alternate inference program, a method for alternate inference control, and an alternate inference system.

### BACKGROUND

A technique has been known which offloads an inference process based on data such as images photographed by an edge device such as a camera (hereinafter sometimes referred to as End Point (EP)) to an edge server located near to the EP.

According to the technique, since the communication path between the EP and the edge server is made shorter as compared with a case where the inference process is offloaded to a cloud server, for example, the communication becomes low latency, so that the EP can be utilized for applications that require more real-time performance.

[Patent Document 1] Japanese Laid-Open
Patent Publication No. 2013-196235

Unlike cloud servers, the technique described above has difficulty in flexibly increasing the number of edge servers. For this reason, a system which utilizes EPs will be prepared in advance with a suitable number of edge servers for the number of EPs in order to guarantee low latency in communication.

However, if an edge server fails in this system, the remaining edge servers will take over, as alternate devices, the inference process being performed by the failed edge server, which may increase the processing load of the remaining edge servers and may not guarantee the low latency in communication.

In order to guarantee low latency in communication even when an edge server fails, one of the conceivable methods is to suppress increase in inference process time by the remaining edge servers performing the inference process, using a lighter machine learning model than the original machine learning model (e.g., object recognition model). Hereinafter, a machine learning model may be simply referred to as “model”.

However, since a lightweight model often has lower inference accuracy than the original model, an inference process based on a lightweight model may degrade the inference accuracy, for example, object recognition accuracy.

### SUMMARY

According to an aspect of the embodiments, a non-transitory computer-readable recording medium having stored therein an alternate inference control program for causing a computer to execute a process including: receiving first image data from a mobile device that photographs the first image data from a variable position; transmitting the first image data to a first server that executes an inference process, based on the first model, on the first image data; receiving second image data being same in a pixel number and a recognition target for the inference process as the first image data from a fixed device that photographs the second image data from a fixed position; and when determining that two pieces of the second image data received from the fixed device continuously in time series have no difference from each other under a state where a failure of the first server is detected, transmitting the first image data to a second server that executes an inference process, based on a second model, on the second image data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating an example of a Multi-access Edge Computing (MEC) system;

FIG. 2 is a diagram illustrating an MEC system according to one embodiment;

FIG. 3 is a block diagram schematically illustrating an example of a hardware (HW) configuration of a computer that achieves the function of a Gateway (GW) server according to the one embodiment;

FIG. 4 is a diagram illustrating an example of a model table;

FIG. 5 is a diagram illustrating an example of a server table;

FIG. 6 is a diagram illustrating an example of executability of an alternate inference process using an alternate model;

FIG. 7 is a diagram illustrating an example of execution of an alternate inference process when an alternate server is executing an inference process;

FIG. 8 is a flow diagram illustrating an example of operation of a preliminary setting process by the GW server according to the one embodiment;

FIG. 9 is a flow diagram illustrating an example of operation of a fallback process by the GW server according to the one embodiment;

FIG. 10 is a flow diagram illustrating an example of operation of alternate inference control by the GW server according to the one embodiment; and

FIG. 11 is a diagram illustrating an example of operation of the alternate inference control according to the one embodiment.

### DESCRIPTION OF EMBODIMENT(S)

Hereinafter, an embodiment of the present invention will now be described with reference to the accompanying drawings. However, the embodiment described below is merely illustrative and there is no intention to exclude the application of various modifications and techniques that are not explicitly described below. For example, the present embodiment can be variously modified and implemented without departing from the scope thereof. In the drawings to be used in the following description, like reference numbers denote the same or similar parts, unless otherwise specified.

(A) Multi-Access Edge Computing (MEC) System:

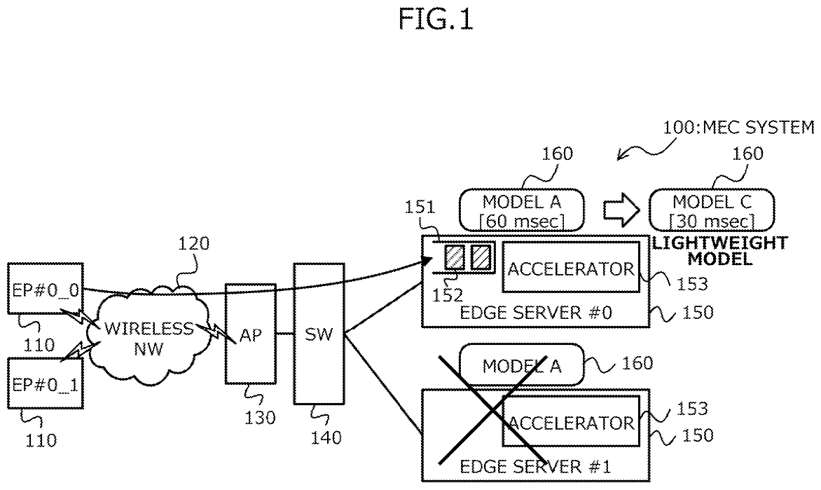

FIG. 1 is a block diagram illustrating an example of an MEC system 100. The MEC system 100 is an example of a system that offloads an inference process on data 152 photographed by an EP 110 to an edge server 150 arranged near to the EP 110 to execute the inference process. An example of the EP 110 is a camera, and an example of the data 152 is one or more frames (image frames).

As illustrated in FIG. 1, the EP 110 transmits the data 152 to an edge server 150 via a wireless network (NW) 120, an access point (AP) 130, and a switch (SW) 140. The edge server 150 stores the received data 152 in the queue 151 of a FIFO (First-In First-Out) type, for example, reads the data 152 in the order of the registration in the queue 151, and inputs the read data 152 into an accelerator 153.

The accelerator 153 inputs the data 152 into a model 160, execute an inference process, and outputs an inference result. The model 160 may be information stored in a storing region of the edge server 150. The edge server 150 may transmit the inference result to a destination via the SW 140 or another non-illustrated communication device, and a non-illustrated network.

Here, in the MEC system 100, an upper limit (target value) of the processing time of the inference processing (inference process time) may be set. For example, the upper limit is assumed to be 60 milliseconds (msec). It is also assumed that the inference process time for one piece (frame) of the data 152 using the model 160 (denoted as “model A”) is 60 milliseconds. In this case, the MEC system 100 prepares two edge servers 150, and causes the two edge servers 150 to each treat one of two EPs 110, so that the inference process time can be made to be the upper limit or less.

In the example illustrated in FIG. 1, a first edge server 150 (denoted as “edge server #0”) executes an inference process based on the model 160 on the data 152 obtained by a first EP 110 (denoted as “EP #0_0”). A second edge server 150 (denoted as “edge server #1”) executes an inference process based on the model 160 on the data 152 obtained by a second EP 110 (denoted as “EP #0_1”).

In the MEC system 100, if, for example, the edge servers 150 decreases due to a failure of the edge server #1, the edge server #0 will execute the inference process on the data 152 obtained by the EP #0_1 in addition to the data obtained by the EP #0_0. For example, it is assumed that process requests for processing the data 152 are input into the edge server #0 at nearly the same time from the EP #0_0 and the EP #0_1 in this order. In this case, since the edge server #0 can start the process request from the EP #0_1 after 60 milliseconds, when the process request from the EP #0_0 is completed, the inference process time of the processing request from the EP #0_1 is 120 milliseconds at the longest from the reception.

To deal with the circumference after the failure of the edge server #1, the edge server #0 uses a model 160 (denoted as “model C”) lighter than the model 160 for the inference process. An example of the model C is a machine learning model capable of executing an inference process faster than the model A. As an example, the inference process time using the model C for one data 152 (frame) is assumed to be 30 milliseconds.

In this case, the edge server #0 can reduce the total inference process time of the two pieces of the data 152 inputted from both of the EP #0_0 and the EP #0_1 to 60 milliseconds, in other words, the upper limit or less by using the model C. Therefore, the inference process time of the entire MEC system 100 can be made to be approximately the same as the inference process time before the failure of the edge server #1.

The lightweight model C is, for example, a model of a neural network in which the number of layers and the like are reduced as compared with the model A, and achieves a reduction in computation time in exchange for degradation in inference accuracy. Therefore, simply replacing the model used by the edge server #0 from the model A to the model C degrades the inference accuracy.

One of examples of a method for reducing the inference process time while suppressing the degradation in the inference accuracy is a thinning process using a technique of detecting a difference between frames.

The thinning process is a method of achieving a rapid recognition process by detecting a difference between frames sequentially inputted to an inference process such as an object recognition and, if the frames have no difference, reusing a previous recognition result in the inference process, thereby reducing the number of frames to be processed.

The thinning process is a technique capable of reducing the number of frames to be processed when there is no difference between frames as described above, and is useful for reducing the processing load of the edge server 150 when the EP 110 is a fixed device such as a fixed camera.

On the other hand, if the EP 110 is a mobile device, such as an Unmanned Aircraft Vehicle (UAV; drone) or an on-board camera, for example, the frames frequently have differences. Accordingly it is difficult to apply the thinning process utilizing a method for detecting a difference between frames to the MEC system 100.

Another conceivable solution is to provide a spare edge server 150 to the MEC system 100 in preparation for a failure of the edge server 150. However, increasing the spare edge servers 150 increase the cost for constructing and operating the MEC system 100. Further, the less number of spare edge servers 150 is more likely to degrade the inference accuracy when edge servers 150 are simultaneously failed. Otherwise, the resource of the edge servers 150 may be used in an inference process having a higher priority and accordingly, there is possibility that another inference process cannot be executed.

Considering the above, the one embodiment will now be describe a method for, when a server will execute an inference process as an alternate of another sever, suppressing degradation in accuracy when inference is performed by using a lighter model than that used by the other server.

(B) Example of Configuration of System:

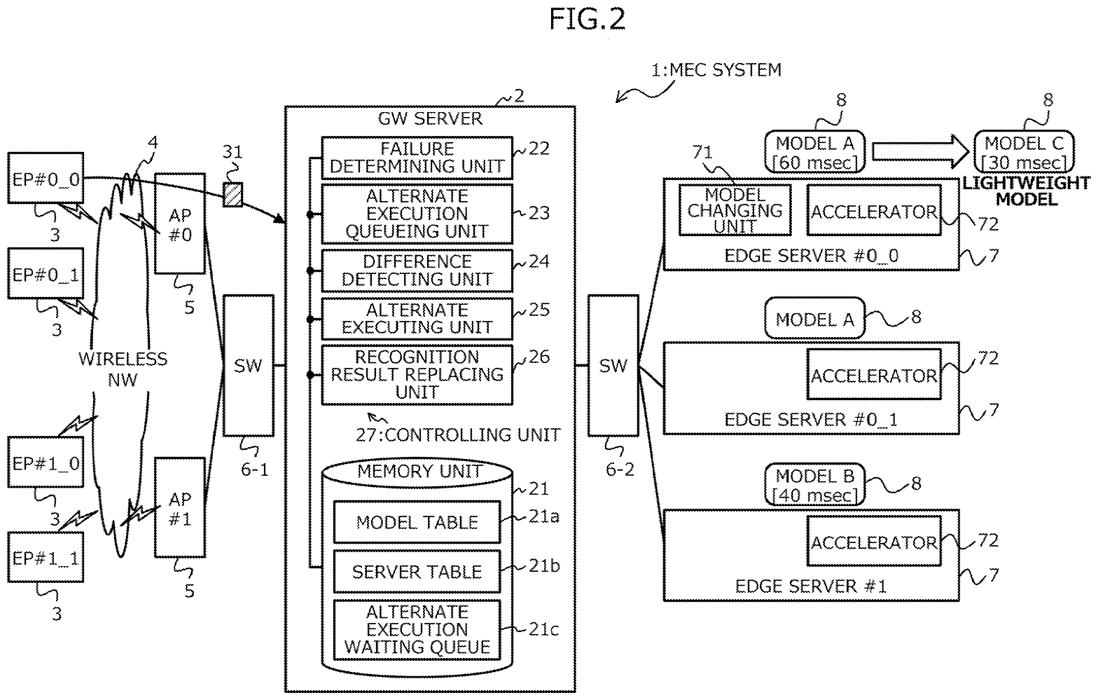

FIG. 2 is a diagram illustrating an example of the configuration of the MEC system 1 according to the one embodiment. As illustrated in FIG. 2, the MEC system 1 may illustratively include a GW server 2, multiple (four in FIG. 2) EPs 3, a wireless NW 4, multiple (two in FIG. 2) APs 5, multiple (two in FIG. 2) SWs 6-1 and 6-2, and multiple (three in FIG. 2) edge servers 7.

The MEC system 1 is an example of a system that offloads an inference process based on data 31 obtained by an EP 3 to an edge server 7 arranged near to the EP 3 to execute the inference process. The MEC system 1 according to the one embodiment is an example of an alternative inference system in which an edge server 7 executes the inference process of a failed edge server 7 in place of the failed edge server 7 under the control of the GW server 2.

The gateway (GW) server 2 is an example of a computer or an information processing apparatus that executes alternate inference control. The GW server 2 transmits a process request for data 31 inputted from the SW 6-1 to the edge server 7, which executes the inference process on the data 31, via the SW 6-2. When receiving a process result of an inference process from the edge server 7, the GW server 2 may transmit the process result to a destination through the SW 6-1 and SW 6-2 or via another non-illustrated communication device and a non-illustrated network.

An EP 3 is an edge device such as a camera, and is an example of an output device for obtaining and outputting the data 31. The data 31 may be, for example, one or more frames (image frames; image data), and in the one embodiment, is assumed to be one frame. For example, the EP 3 transmits the acquired data 31 to the GW server 2 via the wireless NW 4, the AP 5, and the SW 6-1. The obtaining and outputting of the data 31 by the EP 3 may be accomplished by an application executed by the EP 3.

Here, the MEC system 1 according to the one embodiment is assumed to arrange the EPs 3 that output image data the same in pixel number (e.g., frame size) and recognition target (e.g., category) for inference process in the same GW server 2. Further, it is assumed that the multiple EPs 3 arranged in the same GW server 2 are determined so as to include a combination of an EP 3 of a fixed device benefitted from detecting a difference between frames and an EP 3 of a mobile device not benefitted from detecting a difference between frames.

An example of the combination of EPs 3 may be determined by selecting at least one of the EPs 3 of mobile devices and at least one of the EPs 3 of fixed devices. The above-described arrangement may be determined, with reference to the configuration information of the MEC system 1 (EPs 3), by the GW server 2 or a user such as an administrator.

In the one embodiment, the two EPs 3 labeled with reference signs #0 (i.e., the EPs #0_0 and #0_1; hereinafter simply referred to the EP #0 if not distinguishing from each other) are assumed to be mobile devices such as UAVs or on-board cameras. The EP #0 is an example of a first device which is a mobile device that photographs the data 31 from a variable position. The data 31 transmitted by the EP #0 is an example of the first image data.

Further, the two EPs 3 labeled with reference signs #1 (i.e., the EPs #1_0 and #1_1; hereinafter, simply referred to as EP #1 if not distinguishing from each other) are assumed to be fixed devices such as fixed cameras, differently from the EPs #0. The EP #1 is an example of a second device which is a fixed device that photographs the data 31 from a fixed position. The data 31 that the EP #1 transmits is an example of the second image data.

The MEC system 1 may allocate the EPs 3 of which inference model has a common input frame size and a common output category of inference results to one GW server 2. In other words, the MEC system 1 may prepare a GW server 2 for each combination of a frame size and a category of the object recognition.

The following explanation assumes that, when a failure has not occurred in the edge servers 7, the transmission of the data 31 from the EP #0 and the inference process on the data 31 are executed by the group of devices labeled with a reference sign #0 and the group is sometimes referred to as a “#0 group”. In addition, when a failure has occurred in an edge servers 7, the transmission of the data 31 from the EP #1 and the inference process on the data 31 are executed by the group of devices labeled with a reference sign #1 and the group is sometimes referred to as a “#1 group”.

An example of the wireless NW 4 may be a network using various short-range wireless communication schemes such as wireless Local Area Network (LAN) and Bluetooth (registered trademark). Instead of or in addition to the wireless NW 4, the MEC system 1 may include another wired NW, such as a wired LAN and a FC (Fibre Channel). For example, one or the both of the EPs #1, which are fixed devices, may be connected to the AP 5 or the SW 6-1 via a wired NW.

The AP 5 is a communication device that communicably connects the wireless NW 4 and the SW 6-1 (i.e., a network including the SW 6-1, the GW server 2, SW 6-2, and the edge servers 7) to each other. The AP #0 belonging to the #0 group is arranged, for example, near to the EPs #0, and connects each of the EPs #0 to the SW 6-1. The AP #1 belonging to the #1 group is arranged, for example, near to the EPs #1, and connects each of the EPs #1 to the SW 6-1.

The SW 6-1 is a communication device that communicably connects each of the APs #0 and #1 to the GW server 2.

The SW 6-2 is a communication device that communicably connects the GW server 2 to each of the edge servers 7 (each of edge servers #0_0, #0_1, and #1).

Each edge server 7 executes an inference process on the data 31, using the model 8. For example, the edge server 7 may include a model changing unit 71, an accelerator 72, a queue, and a storing region that stores the model 8. In FIG. 2, illustration of the queue and the storing region is omitted.

The model changing unit 71 changes the model 8 to be used for the inference process in response to an instruction from the GW server 2. For example, the model changing unit 71 of the edge server #0_0 changes the model 8 to be used for an inference process from a model A to a lightweight model C in response to an instruction from the GW server 2. Although FIG. 2 illustrates an example in which the edge server #0_0 includes the model changing unit 71, the present invention is not limited to this example. At least one of the multiple edge servers 7 may include the model changing unit 71.

For example, the edge server 7 stores the data 31 received from the SW 6-2 in a queue of a FIFO (First-In First-Out) type, reads the data 31 in the order of registration in the queue, and inputs the read data 31 into the accelerator 72.

The accelerator 72 performs an inference process using the data 31, and outputs an inference result. Examples of the accelerator 72 include an integrated circuit (IC; Integrated Circuit) such as a Graphics Processing Unit (GPU), an Accelerated Processing Unit (APU), a Digital Signal Processor (DSP), an Application Specific IC (ASIC), and a Field-Programmable Gate Array (FPGA).

The edge server 7 may transmit an inference result outputted from the accelerator 72 to the GW server 2.

The models 8 (denoted as models A, B, C) are machine learning models trained to execute an inference process, such as object recognition, on the data 31 received from the EP 3. Each of the models A, B and C illustrated in FIG. 2 can be different in inference process times and also in inference accuracy, but are applicable to inference process on both the data 31 from EP #0 and the data 31 from EP #1.

(C) Example of Configuration of GW Server:

Next, description will now be made in relation to an example of the configuration of the GW server 2 illustrated in FIG. 2.

(C-1) Example of Hardware Configuration:

The GW server 2 according to the one embodiment may be a virtual server (Virtual Machine: VM) or a physical server. The function of the GW server 2 may be realized by one computer or by two or more computers.

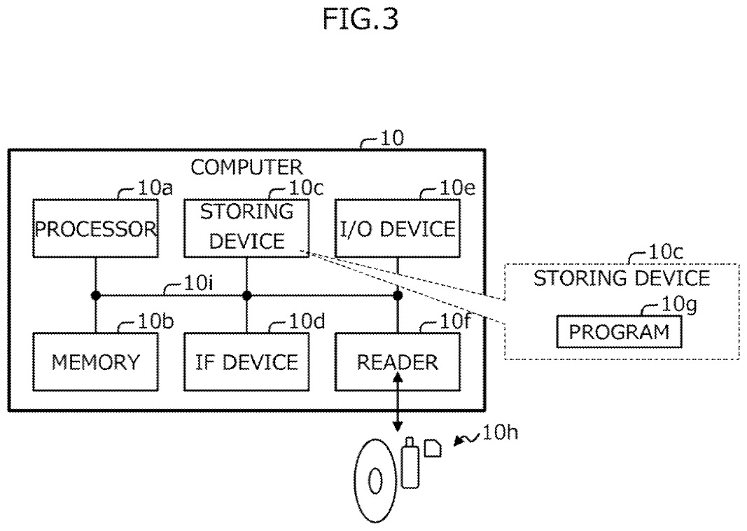

FIG. 3 is a block diagram schematically illustrating an example of a hardware (HW) configuration of a computer 10 that achieves a function of the GW server 2 according to the one embodiment. If multiple computers are used as a HW resources that achieves the function of the GW server 2, each computer may have the configuration illustrated in FIG. 3.

As illustrated in FIG. 3, the computer 10 may illustratively include, as the HW configuration, a processor 10a, a memory 10b, a storing device 10c, an InterFace (IF) device 10d, an Input-Output device 10e, and a reader 10f.

The processor 10a is an example of an arithmetic processing device that performs various types of control and calculations. The processor 10a may be communicably connected to each of the blocks in the computer 10 via a bus 10i. The processor 10a may be a multi-processor including multiple processors and a multi-core processor including multiple processor cores, and may have a structure including multi-core processors.

The processor 10a may be any one of integrated circuits (ICs) such as Central Processing Units (CPUs), Micro Processing Units (MPUs), Graphics Processing Units (GPUs), Accelerated Processing Units (APUs), Digital Signal Processors (DSPs), Application Specific Integrated Circuits (ASICs), and Field Programmable Gate Arrays (FPGAs), or combinations of two or more of these ICs.

The memory 10b is an example of HW that stores various data and programs. The memory 10b may be one or the both of a volatile memory such as a Dynamic Random Access Memory (DRAM) and a non-volatile memory such as a Persistent Memory (PM).

The storing device 10c is an example of HW that stores various data, programs, and the likes. Examples of the storing device 10c may be various storing devices including a magnetic disk device such as a Hard Disk Drive (HDD), a semiconductor drive device such as a Solid State Drive (SSD), and a nonvolatile memory. The non-volatile memory may be, for example, a flash memory, a Storage Class Memory (SCM), a Read Only Memory (ROM), and the like.

The storing device 10c may store a program (alternate inference control program) 10g that implements all or a part of various functions of the computer 10.

For example, the processor 10a of the GW server 2 can achieve the function of the GW server 2 (e.g., the controlling unit 27 illustrated in FIG. 2) by expanding the program 10g stored in the storing device 10c on the memory 10b and executing the expanded program 10g.

The IF device 10d is an example of a communication IF that controls connection and communication of the GW server 2 with the SW 6-1, the SW 6-2 and a non-illustrated network. For example, the IF device 10d may include an applying adapter conforming to Local Area Network (LAN) such as Ethernet (registered trademark) or optical communication such as Fibre Channel (FC). The applying adapter may be compatible with one of or both of wireless and wired communication schemes.

For example, the GW server 2 may be communicably connected to each of the EPs 3 and the edge servers 7 via IF device 10d and the network. Furthermore, the program log may be downloaded from the network to the computer 10 through the communication IF and be stored in the storing device 10c.

The IC device 10e may include one or both of an input device and an output device. Examples of the input device include a keyboard, a mouse, and a touch panel. Examples of the output device include a monitor, a projector, and a printer. The IC device 10e may include, for example, a touch panel that integrates an input device and an output device with each other.

The reader 10f is an example of a reader that reads data and programs recorded on a recording medium 10h. The reader 10f may include a connecting terminal or device to which the recording medium 10h can be connected or inserted. Examples of the reader 10f include an applying adapter conforming to, for example, Universal Serial Bus (USB), a drive apparatus that accesses a recording disk, and a card reader that accesses a flash memory such as an SD card. The program 10g may be stored in the recording medium 10h. The reader 10f may read the program 10g from the recording medium 10h and store the read program 10g into the storing device 10c.

The recording medium 10h is an example of a non-transitory computer-readable recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the computer 10 described above is illustrative. Accordingly, the computer 10 may appropriately undergo increase or decrease of HW devices (e.g., addition or deletion of arbitrary blocks), division, integration in an arbitrary combination, and addition or deletion of the bus.

The edge server 7 may be achieved by, for example, a computer or an information processing apparatus such as a server. A computer that achieves the edge server 7 may have the same hardware configuration as the above-described computer 10.

(C-2) Example of Functional Configuration:

Next, description will now be made in relation to an example of the functional configuration of the GW server 2 with reference to FIG. 2. As illustrated in FIG. 2, the GW server 2 may illustratively include a memory unit 21, a failure determining unit 22, an alternate execution queuing unit 23, a difference detecting unit 24, an alternate executing unit 25, and a recognition result replacing unit 26. The failure determining unit 22, the alternate execution queuing unit 23, the difference detecting unit 24, the alternate executing unit 25, and the recognition result replacing unit 26 are an example of a controlling unit 27.

The memory unit 21 is an example of a storing region and stores various data used by the GW server 2. The memory unit 21 may be achieved by, for example, a storing region included in one or the both of a memory 10b and a storing device 10c illustrated in FIG. 3.

As illustrated in FIG. 2, the memory unit 21 may illustratively be capable of storing a model table 21a and a server table 21b, and may include a storing region used as an alternate execution waiting queue 21c. Hereinafter, the model table 21a and the server table 21b are each illustrated in a table format for convenience, but the present invention is not limited to this. Alternatively, the model table 21a and the server table 21b may be each stored in various formats such as an array or a database (DB).

The GW server 2 (controlling unit 27) may create the model table 21a and the server table 21b as a preliminary setting process prior to starting the operation with the MEC system 1.

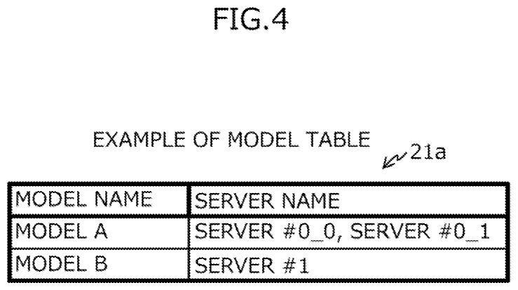

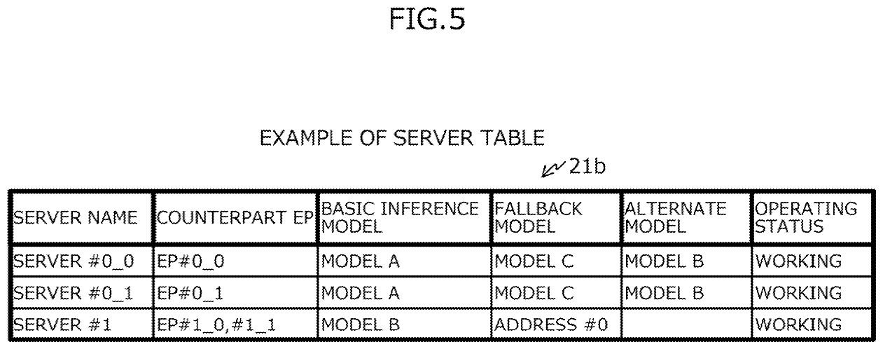

FIG. 4 is a diagram illustrating an example of the model table 21a; and FIG. 5 is a diagram illustrating an example of the server table 21b.

The model table 21a is an example of information indicating the association of the models 8 (models A, B, C) with the edge servers 7. As illustrated in FIG. 4, the model table 21a may illustratively include fields of “model name” and “server name”. The “model name” is an example of the identification information of each model 8 provided in the MEC system 1. The server name is an example of the identification information of each edge server 7 that stores the model 8 of the corresponding model name and uses the model 8 for an inference process.

The server table 21b is an example of information indicating a model 8 to be used in fallback environment when a failure occurs in the edge server 7. As illustrated in FIG. 5, the server table 21b may illustratively include fields of “server name”, “counterpart EP”, “basic inference model”, “fallback model”, “alternate model”, and “operating status”.

The server name is an example of the identification information of the edge server 7. The counterpart EP is an example of the identification information of the EP 3 the inference process of which is handled (performed) by the edge server 7 (the identification information of the EP 3 corresponding to the edge server 7 performing the inference process of the EP 3). The basic inference model indicates a model 8 used by the edge server 7 for the inference process in a state in which the edge server 7 does not fail (a state in which the MEC system 1 is operating normally).

The fallback model indicates a lightweight model 8 used in environment (fallback environment) in which a failure occurs in the edge server 7 and the edge server 7 is fallen back. In the field of “fallback model”, an address (e.g., an IP (Internet Protocol) address) to specify another edge server 7 that alternatively executes the inference process when the edge server 7 fails may be set in place of the information indicating the model 8. As an example, as illustrated in FIG. 5, an “address #0” set in the field of “fallback model” of the server #1 indicates the address of an edge server 7 that performs a fallback process on the data 31 from the EP #1 in the event of the failure of the server #1. The alternate model indicates an alternate model 8 used in fallback environment. The operation status indicates whether or not the edge server 7 is operating, for example, “working” or “failed”.

In the following description, along with the server table 21b illustrated in FIG. 5, in relation to the group #0, the model A may be denoted as the basic inference model A, the model B may be denoted as the alternate model B, and the model C may be denoted as the fallback model C. The basic inference model A is an example of a first model, and the fallback model C is an example of a third model that takes a shorter inference process time than the basic inference model A. The alternate model B is an example of a second model that has a shorter inference process time than the basic inference model A and that has a longer inference process time than the fallback model C.

One or the both of the model table 21a and the server table 21b may be generated by a user such as an administrator of the MEC system 1 and stored in the memory unit 21.

The GW server 2 may generate the model table 21a and the server table 21b according to the above-described arrangement condition and the constraint condition in the MEC system 1 in the preliminary setting process.

Examples of the constraint condition include, for example, that the upper limit of the inference process time of the EP #0 is “60” milliseconds or the like, that the inference process time of the alternate model B is less than that of the basic inference model A and longer than that of the fallback model C. The GW server 2 may exclude a model 8 that does not satisfy the constraint condition from a model to be set to a fallback model or an alternate model of the server table 21b.

The GW server 2 carries out transfer control that transfers the processing request for data 31 to the edge server 7, for example, such that the group #0 processes the data 31 from the EP #0 and the group #1 processes the data 31 from the EP #1, with reference to the model table 21a and the server table 21b.

Further, for example, the GW server 2 carries out transfer control that transmits, when a failure occurs in the edge server #0_1 of the #0 group, the processing request to edge server #0_0 such that the inference process of the #0 group is executed using the lightweight model C. The following description assumes that a failure occurs in the edge server #0_1.

The failed edge server #0_1 is an example of the first server that executes the inference process based on the first model. It can be said that the edge server #0_1 belongs to a server group (#0 group) which executes the inference process, based on the model A, on the data 31 received from the EP #0.

The failure determining unit 22 determines whether or not the edge server 7 has failed. For example, the failure determining unit 22 periodically monitors each edge server 7 that GW server 2 is in charge of (e.g., that are registered in the server table 21b) to determine whether or not the edge sever 7 has a failure.

In the event of detecting a failure of the edge server 7, the failure determining unit 22 notifies each edge server 7 except for the failed edge server 7 in server table 21b that the edge server 7 has failed.

The notification may include a fallback instruction to an edge server (hereinafter sometimes referred to as “fallback inference server”) 7 that uses the same model 8 as the failed edge server 7. The fallback inference server 7 is an edge server 7 (#0_0 in the example of FIG. 2) that performs a fallback inference process on behalf of the failed edge server 7. The edge server #0_0 is an example of the third server that belongs to a server group (the #0 group) and that executes the inference processing based on the model C.

The failure determining unit 22 instructs the edge server #0_0, which is different from the failed edge server #0_1, to switch from the model A to the model C in this manner.

For example, if the edge server #0_1 fails, the failure determining unit 22 changes the operating status of the edge server #0_1 in server table 21b to “failed”. Also, the failure determining unit 22 specifies the edge server (fallback inference server) #0_0 that executes the same model A as the edge server #0_1 and specifies the fallback model C of the edge server #0_0 with reference to the server table 21b. Then, the failure determining unit 22 may notify the model changing unit 71 of the edge server #0_0 of an instruction to change the basic inference model A to the specified fallback model C.

The failure determining unit 22 may generate an entry of the fallback model C in the model table 21a and set the entry in association with edge server #0_0, and in this case, may remove the edge server #0_0 from the entry of the model A.

When receiving the input of data 31 directed to the fallback inference server 7 (for example, #0_0), for example, the input of data 31 from the EP #0_0 or the EP #0_1, the alternate execution queuing unit 23 registers the received data 31 in the alternate execution waiting queue 21c.

The alternate execution waiting queue 21c may be, for example, a queue of the FIFO type, and may be capable of storing multiple pieces of the data 31.

The difference detecting unit 24 executes a difference detecting process on data 31 inputted from the EP 3 assigned to an edge server 7. This edge server 7 is a server (hereinafter referred to as “alternate server”) that is to execute the alternate model B.

For example, the difference detecting unit 24 may specify the edge server #1 of the group #1 that uses the alternate model B of the group #0 as the “basic inference model” by referring to the server table 21b (see FIG. 5) and specify the EP #1 as the counterpart EP 3 of the edge server #1. The alternate server #1 is an example of the second server that belongs to the server group (#1 group) that executes the inference process based on the model B on the data 31 received from the EP #1.

Since the EP #1 is a fixed device of the #1 group, the data 31 inputted from EP #1 (EP #1_0 and #1_1) to the GW server 2 is a candidate for a processing target of a thinning process using a technique of detecting a difference between frames. That is, the edge server #1 has possibility of shortening the inference process time by the thinning process performed on the data 31 from the EP #1 and being able to executing the inference process on the data 31 registered in the alternate execution waiting queue 21c utilizing the shortened time.

For this purpose, the difference detecting unit 24 detects whether or not the data 31 inputted from the EP #1 is a processing target of the thinning process in the edge server #1 at the time when the data 31 is inputted to the GW server 2.

As one example, the difference detecting unit 24 may determine, in the difference detecting process, whether or not there is a difference between the data 31 inputted from the EP #1 and the data 31 inputted immediately before from the EP #1 in the same method as a process of detecting a difference between frames executed in the edge server #1. In other words, the difference detecting unit 24 determines whether the two pieces of the data 31 received continuously in time series from the EP #1_0 or #1_1 have a difference from each other.

When determining that the data 31 and the data 31 immediately before have no difference, in other words, when the edge server #1 suppresses (skips) the execution of the inference process on the data 31, the difference detecting unit 24 may notify the alternate executing unit 25 of no difference.

On the other hand, when determining that the data 31 and the data 31 immediately before have a difference, in other words, when the edge server #1 executes the inference process on the data 31, the difference detecting unit 24 may notify the alternate executing unit 25 of the presence (having) a difference.

On the basis of the registration status of the data 31 in the alternate execution waiting queue 21c and the notification from the difference detecting unit 24, the alternate executing unit 25 performs control to execute the inference process (alternate inference process) based on the alternative model B on the data 31 registered in the alternate execution waiting queue 21c.

For example, the alternate executing unit 25 determines whether or not the alternate inference process based on the alternate model B on the data 31 is completed in the edge server #1 within the upper limit (e.g., “60” milliseconds) of the inference process on the data 31 since the data 31 has been registered in the alternate execution waiting queue 21c.

As an example, the alternate executing unit 25 may determine that the alternate inference process is to be performed if the relationship between the input timing at which the data 31 is inputted to the alternate execution waiting queue 21c and the notification timing of no difference from the difference detecting unit 24 satisfies the following Expression (1).

limit_time>=wait_time+alt_proc_time (1)

In the above Expression (1), the term “limit time” represents the upper limit of the inference process time on the data 31 from the EP #0, in other words, the completion time (expected completion time) expected for the inference process on the data 31 from the EP #0, and is, for example, “60” milliseconds. The term “wait_time” represents the wait time (elapsed time) from inputting of the data 31 into the alternate execution waiting queue 21c to receiving of the notification of no difference, and is for example, the time obtained by subtracting the inputting timing (time of the day) from the notification timing (time of the day). The term “alt_proc_time” represents the inference process time (alternate inference process time) by the alternate server #1 using the alternate model B, and is, for example, the time required for the inference process exemplified by “40” milliseconds.

The above Expression (1) is transformed to the following Expression (2), which can be said that the execution condition for the alternate inference process is satisfied if the notification timing is equal to or less than the “(limit_time)−(alt_proc_time)” from the inputting timing. The “limit_time−alt_proc_time” is an example of a tolerance time based on a registering timing of the data 31 into the alternate execution waiting queue 21c, the upper limit of the inference process time on the data 31, and an inference process time on the data 31 by the alternate server #1 using the alternate model B.

wait_time<=limit_time−alt_proc_time (2)

As described above, if receiving notification of no difference (determined to have no difference) from the difference detecting unit 24 within the tolerance time, the alternate executing unit 25 reads the data 31 stored in the alternate execution waiting queue 21c and transfers the read data 31 to the alternate server #1. This allows the alternate server #1 to execute the alternate inference process based on the alternate model B. The alternative server #1 executes the alternate inference process by causing the accelerator 72 to use the alternate model B, and outputs the inference result to the GW server 2.

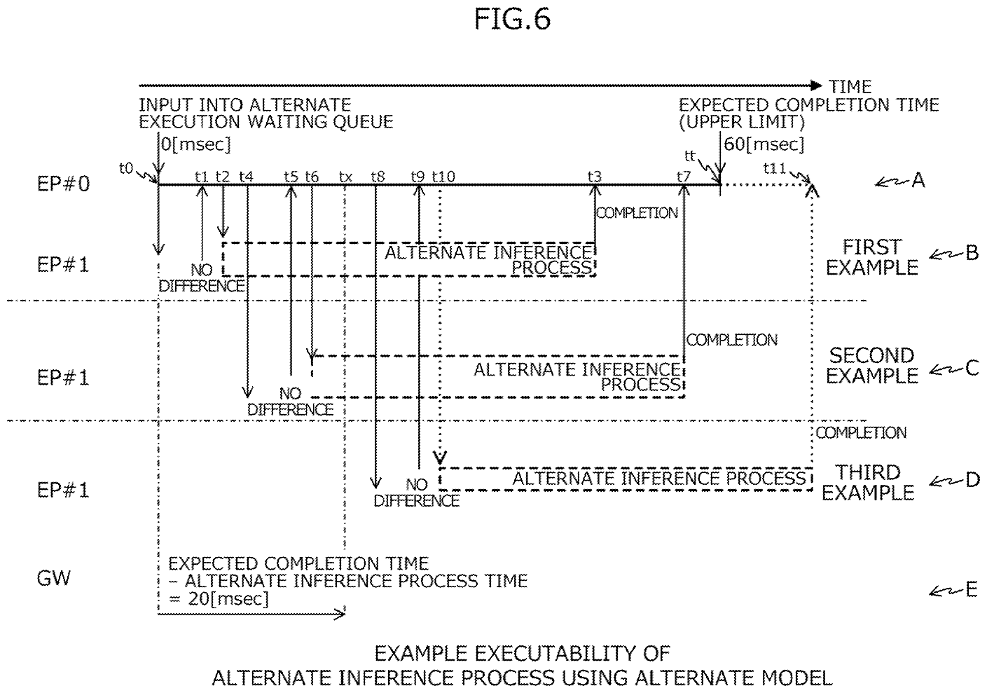

FIG. 6 is a diagram illustrating an example of executability of an alternate inference process based on the alternate model B. FIG. 6 illustrates whether or not the execution condition for the alternate inference process is satisfied for each execution timing (or notification timing) of the difference detecting process by the difference detecting unit 24 with reference to the first to third examples. FIG. 6 illustrates a state where the inference process is not being executed in the alternate server #1 at the inputting timing of the data 31 to the alternate execution waiting queue 21.

In FIG. 6, the abscissa represents time. The axis of EP #0 indicated by Arrow A indicates the elapsed time since the data 31 from the EP #0 has been registered (inputted) in the alternate execution waiting queue 21c.

In the first example illustrated by Arrow B, the data 31 is inputted from the EP #1 to the GW server 2 at substantially the same time as the inputting timing t0 at which the data 31 from the EP #0 is inputted to the alternate execution waiting queue 21c.

The difference detecting unit 24 executes the difference detecting process on the data 31 from the EP #1, and notifies the alternate executing unit 25 of no difference at t1. The alternate executing unit 25 determines that the execution condition is satisfied by the determination of the above Expression (1) or (2). In this case, the alternate executing unit 25 reads one piece of the data 31 from the alternate execution waiting queue 21c at t2 and transfers the read data 31 to the alternate server #1. The alternate server #1 executes the alternate inference process, using the alternate model B, on the data 31, and sends the inference (recognition) result to the GW server 2 at t3.

The second example illustrated by Arrow C illustrates a case where notification of no difference is issued from the difference detecting unit 24 to the alternate executing unit 25 within “20” milliseconds from inputting the data 31 from the EP #0 to the alternate execution waiting queue 21c.

The difference detecting unit 24 executes the difference detecting process on the data 31 from the EP #1 at t4, and notifies the alternate executing unit 25 of no difference at t5. The alternate executing unit 25 determines that the execution condition is satisfied by the determination of the above Expression (1) or (2). In this case, the alternate executing unit 25 reads one piece of the data 31 from the alternate execution waiting queue 21c at t6 and transfers the read data 31 to the alternate server #1. The alternate server #1 executes the alternate inference process, using the alternate model B, on the data 31, and sends the inference (recognition) result to the GW server 2 in t7.

The third example illustrated by Arrow D illustrates a case where notification of no difference is issued from the difference detecting unit 24 to the alternate executing unit 25 after “20” milliseconds elapses from inputting the data 31 from the EP #0 to the alternate execution waiting queue 21c.

The difference detecting unit 24 executes the difference detecting process on the data 31 from the EP #1 at t8, and notifies the alternate executing unit 25 of no difference at t9. The alternate executing unit 25 determines that the execution condition is not satisfied by the determination of the above Expression (1) or (2).

In this case, if the alternate inference process is to be executed, the alternate executing unit 25 reads one piece of the data 31 from the alternate execution waiting queue 21c at t10 and transfers the read data 31 to the alternate server #1. The alternate server #1 executes the alternate inference process, using the alternate model B, on the data 31, and sends the inference (recognition) result to the GW server 2 at t11. However, t11 is the timing after tt when the expected completion time (limit_time) expires. That is, in the third example, if the alternate inference process is executed, the expected completion time would not be satisfied.

Therefore, if determining that the execution condition is not satisfied by the determination of the above Expression (1) or (2), the alternate executing unit 25 suppresses the execution of the alternate inference process. For example, the alternate executing unit 25 deletes (removes) the data 31 from alternate execution waiting queue 21c.

In all the first to the third examples, the data 31 (data 31 from the EP #0) is transferred to the fallback inference server #0_0 after being inputted to the GW server 2, and then subjected to the fallback inference process based on the fallback model C. Then, the GW server 2 receives the inference (recognition) result of the fallback inference process from the fallback inference server #0_0 before the expected completion time (limit_time) expires.

Therefore, even if the execution of the alternate inference process is suppressed in the third example, the GW server 2 can receive the inference result of the fallback inference process from the fallback inference server #0_0.

In FIG. 6, Arrow E indicates an example of timing at which alternate executing unit 25 deletes the data 31 from the alternate execution waiting queue 21c. For example, the alternative server #1 may remove the data 31 from the alternate execution waiting queue 21c at a timing tx at which the time “(limit_time)−(alt_proc_time)” has elapsed (“20” milliseconds in the example of FIG. 6) since the inputting timing t0 or after the timing tx. In other words, the alternate executing unit 25 removes the data 31 from the alternate execution waiting queue 21c after the tolerance time has elapsed.

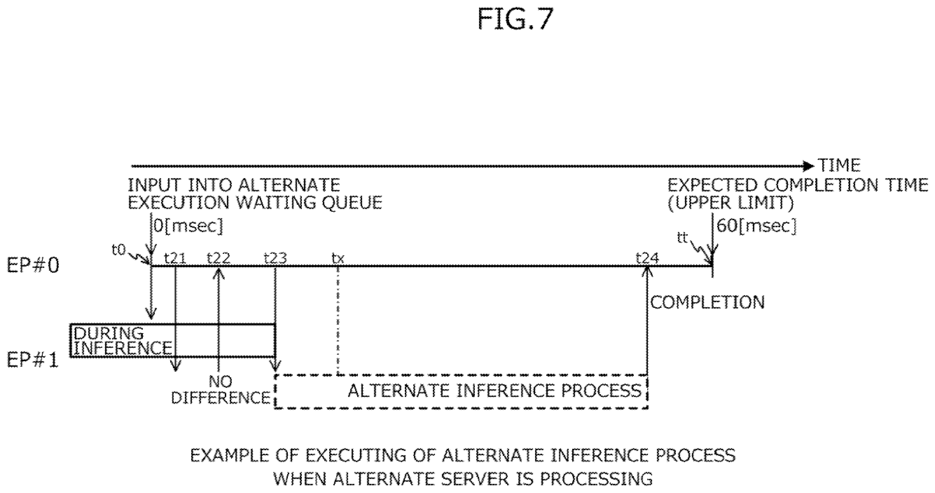

FIG. 7 is a diagram illustrating an example of execution of an alternate inference process when an alternate server #1 is executing an inference process. FIG. 7 shows a case where, if the alternate server #1 is executing the inference process at the inputting timing t0, the data 31 is inputted from the EP #1 to the GW server 2 at the timing t21 during the execution of the inference processing after to.

The difference detecting unit 24 executes the difference detecting process on the data 31 from the EP #1, and notifies the alternate executing unit 25 of no difference at t22.

For example, it is assumed that the alternate executing unit 25 determines that the execution condition is satisfied by the determination of the above Expression (1) or (2).

However, at the timing t22, the alternate server #1 is executing an inference process based on the alternate model B on another data 31. In this case, the completion time of the alternate inference process is delayed by the time from the determination that the execution condition is satisfied to t23, at which the inference process being executed is completed. In addition, if a processing request waiting for being executed by the alternate server #1 already exist at the timing t0, the alternate inference process will be executed after the waiting inference process is completed.

As described above, if a processing request (hereinafter, referred to as “preceding processing request”) being executed or waiting for being executed by the alternate server #1 exists, the alternate inference process has a possibility of not being completed within the expected completion time in the determination based on the above Expression (1) or (2).

For the above, the alternate executing unit 25 determines whether or not a preceding processing request exists, and if exists, obtains a time from t0 to the completion of the inference process (hereinafter referred to as “preceding inference processing”) performed in response to the preceding processing request. For example, alternate executing unit 25 may calculate the preceding completion time (pre_wait_time) from t0 to the completion of the preceding inference process according to the following Expression (3).

pre_wait_time=proc_time+(waiting_req_number*alt_proc_time) (3)

In the above Expression (3), the term “proc_time” represents the time from t0 to the completion of the preceding inference process being executed by the alternate server #1. The term “waiting_req_number” represents the number of preceding inference requests waiting for being executed by the alternate server #1. For example, the alternate executing unit 25 may obtain or calculate the “proc_time” and the “waiting_req_number” on the basis of at least one of the notification of having a difference from the difference detecting unit 24 and history information such as a log when the GW server 2 transfers the data 31 to the alternate server #1.

When the preceding completion time (pre_wait_time) is included in the determination of the execution condition (wait_time), the determination of the above Expression (1) or Expression (2) becomes the following Expression (4) or Expression (5).

limit_time>=wait_time+alt_proc_time+pre_wait_time (4)

wait_time<=limit_time−alt_proc_time−pre_wait_time (5)

If the above Expression (4) or (5) is satisfied, the alternate executing unit 25 may determine that the execution condition for the alternate inference process is satisfied. The determination based on the above Expression (1) or (2) described with reference to FIG. 6 can be regarded as determination made when the preceding completion time (pre_wait_time) in the above Expression (4) or (5) is “0”.

The “(limit_time)−(alt_proc_time)−(pre_wait_time)” is a tolerance time when the preceding inference process including one or both of an inference process that the alternate server #1 is executing and an inference process that is waiting for being executed by the alternate server #1 exists, and is an example of a tolerance time additionally based on a scheduled timing of the completion of the preceding inference process.

In the example of FIG. 7, the preceding inference process being executed is completed at t23, and no inference process waiting for being executed exists. Therefore, the alternate executing unit 25 calculates t23−t0 (≤“20” milliseconds) as the preceding completion time (pre_wait_time), and determines that the execution condition is satisfied by the determination of the above Expression (4) or (5).

For example, the alternate executing unit 25 reads one piece of the data 31 from the alternate execution waiting queue 21c at t23, at which the preceding inference process is completed, and transfers the read data 31 to the alternate server #1. The alternate server #1 executes alternate inference process using the alternate model B on the data 31, and sends the inference (recognition) result to the GW server 2 at t24.

Returning back to the description of FIG. 2, when receiving the recognition result (processing result) of the alternate inference process from the edge server 7, the recognition result replacing unit 26 replaces a result of the fallback process serving as the recognition result that is to be transmitted to the destination by the GW server 2 with the recognition result of the alternate inference process.

For example, in the MEC system 1, when the fallback inference server 7 executes an inference process based on the fallback model C in the fallback environment, the GW server 2 transmits the recognition result of the fallback inference processing received from the fallback inference server 7 to the destination. When the alternate server 7 executes an alternate inference process based on the alternate model B having higher inference accuracy than the fallback model C, the GW server 2 receives the recognition result of the alternate inference process from the alternate server 7 in addition to the recognition result of the fallback inference process.

In this case, the recognition result replacing unit 26 replaces the recognition result to be transmitted by the GW server 2 so that the recognition result of the alternate inference process based on the alternative model B having higher inference accuracy than the fallback model C is transmitted to the destination preferentially over the recognition result of the fallback inference process.

In the first and second examples of FIG. 6 and the example of FIG. 7, the recognition result replacing unit 26 replaces the recognition result received from the fallback inference server #0_0 serving as the recognition result to be transmitted with the recognition result received from the alternate server #1.

The recognition result replacing unit 26 may add the recognition result received from the alternate server #1 to the recognition result received from the fallback inference server #0_0, and regard the both recognition results as the transmission targets.

As described above, the recognition result replacing unit 26 determines, as the inference result to be transmitted to the destination, the inference result of an inference process by the alternate server #1 or the combination of the inference result by the alternate server #1 and an inference result of the inference process based on the fallback model C by the fallback inference server #0_0.

(D) Example of Operation:

Next, an example of operation of the GW server 2 according to the one embodiment will now be described.

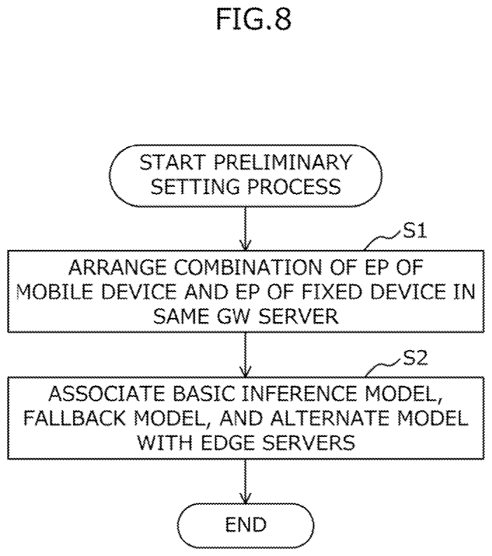

FIG. 8 is a flow diagram illustrating an example of operation of a preliminary setting process by the GW server 2 according to the one embodiment.

As illustrated in FIG. 8, the GW server 2 associates the EP 3 and the edge server 7 with each other such that the combination of the EP #0 of a mobile device and the EP #1 of a fixed device are arranged in the same GW server 2 (Step S1).

The GW server 2 associates the basic inference model A, the fallback model C, and the alternative model B with the edge servers 7 (Step S2), and the preliminary setting process ends. For example, the GW server 2 may generate the model table 21a and the server table 21b and store the tables into the memory unit 21.

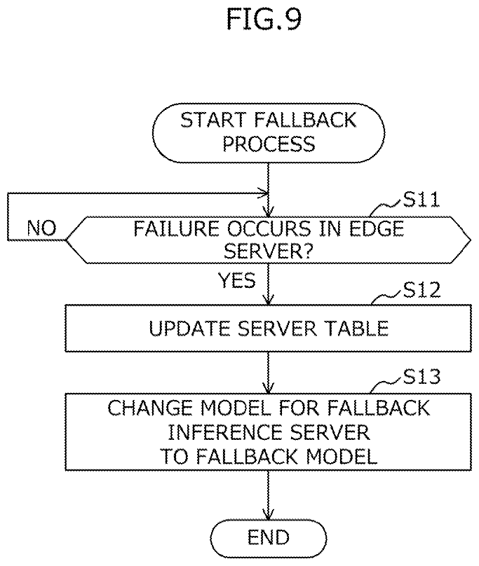

FIG. 9 is a flow diagram illustrating an example of operation of a fallback process by the GW server 2 according to the one embodiment.

As illustrated in FIG. 9, the failure determining unit 22 of the GW server 2 determines whether or not a failure has occurred in the edge server 7 by periodically monitoring the edge server 7 (Step S11; NO in Step S11).

If occurrence of a failure is detected (YES in Step S11), the failure determining unit 22 updates the server table 21b (Step S12). For example, the failure determining unit 22 may update the operating status of the failed edge server 7 (e.g., #0_1) to “failed” in the server table 21b.

The failure determining unit 22 notifies the model changing unit 71 of the edge server (fallback inference server) #0_0 specified with reference to the server table 21b that the edge server #0_1 has failed, causes the fallback inference server A to change the model to the fallback model C (Step S13), and terminates fallback process.

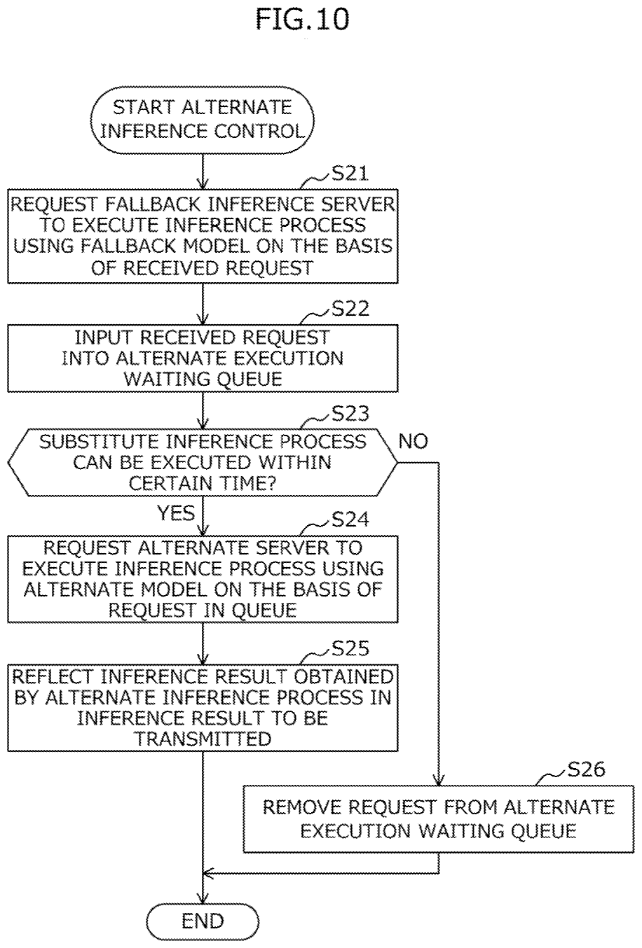

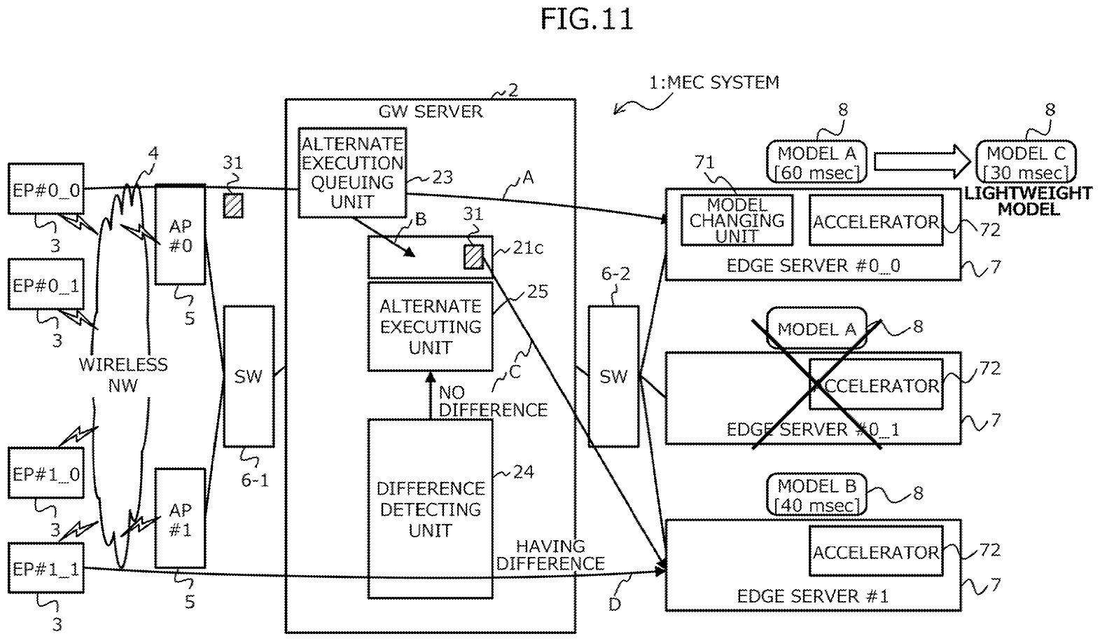

FIG. 10 is a flow diagram illustrating an example of operation of an alternate inference control by the GW server 2 according to the one embodiment, and FIG. 11 is a flow diagram illustrating an example of operation of an alternate inference control by the GW server 2. In FIG. 11, illustration of some functional blocks of the GW server 2 is omitted.

As illustrated in FIG. 10, the GW server 2 requests the fallback inference server #0_0 to perform the inference process based on the fall back model C in response to the received request (Step S21; see symbol A in FIG. 11). For example, the GW server 2 transfers data 31 received from the EP #0 to the fallback inference server #0_0 specified with reference to the server table 21b.

The alternate execution queuing unit 23 inputs the received request into the alternate execution waiting queue 21c (Step S22; see Symbol B in FIG. 11).

The alternate executing unit 25 determines whether or not the alternate server #1 can execute the alternate inference process within a certain of time (e.g., upper limit “60” milliseconds) (Step S23). For example, the difference detecting unit 24 determines whether or not the request to the alternate server #1 has a difference from the immediately previous request, and notifies the alternate executing unit 25 of the determination result. Based on the notification timing from the difference detecting unit 24 and the inputting timing of the request to the alternate execution waiting queue 21c, the alternate executing unit 25 determines whether or not the execution condition for the alternate inference process is satisfied based on the above Expression (4) or Expression (5).

If determining that the alternate inference process can be executed within a certain time (YES in Step S23), the alternate executing unit 25 requests the alternate server #1 to execute the inference process based on the alternate model B in response to the request in the alternate execution waiting queue 21c (Step S24; see a reference sign “C” in FIG. 11).

The recognition result replacing unit 26 reflects the response (recognition result) to the request in Step S24 on the inference result to be transmitted on which the response (recognition result) to the request in Step S21 is reflected (Step S25), and the alternate inference control ends.

If it is determined that alternate inference process cannot be executed within a predetermined period of time (NO in step S23), the alternate executing unit 25 removes the request from the alternate execution waiting queue 21c (step S26), and the alternate inference control ends. In this case, the request to the alternative server #1 is processed, as a normal inference process, by using the basic inference model B in the edge server #1 (see reference symbol “D” in FIG. 11).

As described above, according to the MEC system 1 of the one embodiment, the GW server 2 receives the data 31 from the EP #0 and transmits the data 31 to the edge server #0_1 that executes the inference process based on the model A on the data 31. The GW server 2 receives the second image data from the EP #1, which is different from the EP #0. Further, if detecting a failure in the edge server #0_1 and also determining that the two piece of the data 31 received continuously in time series from the EP #1 have no difference, the GW server 2 transmits the data 31 from the EP #0 to the alternate server #1. The alternate server #1 is a server that executes an inference process based on the model B on the data 31 from EP #1.

As the above, the GW server 2 can detect resource consumption of the alternate server #1 that executes the inference process of the data 31 from the EP #1, and if the resource is not consumed (the alternate server #1 has a resource that can be used), causes the alternate server #1 to process the data 31 from EP #0.

This makes it possible to suppress the degradation of the recognition accuracy of an inference process to be executed in the event of the failure of the edge server 7. Further, by setting the upper limit of the inference process time, the processing time of the inference processing using the alternative model B can be suppressed to the acceptable time.

(E) Miscellaneous:

The technique according to the one embodiment described above can be implemented by changing or modifying as follows.

For example, the functional blocks 22 to 26 included in the GW server 2 illustrated in FIG. 2 may be merged in any combination and may be divided.

Further, the description assumes that the GW server 2 transfers the data 31 inputted from the EP #1 to the edge server #1, but the present invention is not limited to this. Alternatively, the GW server 2 may suppress the transfer of the data 31 that the difference detecting unit 24 determines to have no difference to the edge server #1. This makes it possible to suppress the execution of the difference detecting process in the edge server #1 and also to suppress the transferring process of the data 31 from the GW server 2 to the edge server #1. Accordingly, it is possible to reduce the processing loads of the GW server 2, the SW 6-2, and the edge server #1, and the communication load between the GW server 2 and the edge server #1.

Furthermore, in the one embodiment, the GW server 2 regards, in the fallback environment, the data 31 inputted from all the EPs #0 (EP #0_0 and EP #0_1) as the processing targets by the alternative server #1, which is however not limited to this. Alternatively, the GW server 2 may specify in advance an EP #0 that transmits data 31, the recognition accuracy of which becomes equal to or lower than a predetermined threshold when the inference process using the fallback model C is performed, among all the EPs #0. Then the GW server 2 may set the data 31 received from the specified EP #0 to be the processing target by the alternative server #1.

The one embodiment is described, assuming that the data 31 is a frame (image data), but the embodiment is not limited thereto. Example of the data 31 may be various data that can omit or simplify the inference process according to the difference between the previous piece and subsequent piece of data 31.

In one aspect, the present disclosure can suppress degradation of the accuracy of an inference process after a server failure in a system in which multiple servers perform an inference process.

Throughout the descriptions, the indefinite article “a” or “an” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein an alternate inference control program for causing a computer to execute a process comprising:
receiving first image data from a mobile device that photographs the first image data from a variable position;
transmitting the first image data to a first server that executes an inference process, based on the first model, on the first image data;
receiving second image data being same in a pixel number and a recognition target for the inference process as the first image data from a fixed device that photographs the second image data from a fixed position; and
when determining that two pieces of the second image data received from the fixed device continuously in time series have no difference from each other under a state where a failure of the first server is detected, transmitting the first image data to a second server that executes an inference process, based on a second model, on the second image data.

2. The non-transitory computer-readable recording medium according to claim 1, wherein
the first server belongs to a server group including servers that each execute, using the first mode, the inference process on the first image data, and
the process further comprises:
instructing a third server being different from the first sever and belonging to the server group to switch the first model to a third model that takes a shorter inference process time than the first model; and
transmitting the first image data to the third server.

3. The non-transitory computer-readable recording medium according to claim 2, wherein the second model takes a shorter inference process time than the first model and a longer inference process time than the third model.

4. The non-transitory computer-readable recording medium according to claim 2, wherein the transmitting the first image data to the second server comprises:
registering the first image data into a queue; and
when determining that the two pieces of second image data have no difference within a tolerance time based on a registering timing of the first image data into the queue, an upper limit of an inference process time on the first image data, and an inference process time on the first image data by the second server using the second model, transmitting the first image data registered in the queue to the second server.

5. The non-transitory computer-readable recording medium according to claim 4, wherein the transmitting the first image data to the second server comprises:
under a presence of a preceding inference process including one or the both of an inference process that the second processor is executing and an inference process that is waiting for being processed by the second server,
when determining that the two pieces of second image data have no difference within the tolerance time based on a scheduled timing of completion of the preceding inference process in addition to the registering timing of the first image data into the queue, the upper limit of an inference process time on the first image data, and the inference process time on the first image data by the second server using the second model, transmitting the first image data registered in the queue to the second server.

6. The non-transitory computer-readable recording medium according to claim 4, wherein the process further comprises:
removing the first image data from the queue after the tolerance time elapses.

7. The non-transitory computer-readable recording medium according to claim 2, wherein the process further comprises:
determining, as an inference result to be transmitted to a destination, a first inference result of the inference process executed on the first image data by the second server using the second model or a combination of the first inference result and a second inference result of an inference process executed on the first image data by the third server using the third model.

8. A computer-implemented method for alternate inference control comprising:
receiving first image data from a mobile device that photographs the first image data from a variable position;
transmitting the first image data to a first server that executes an inference process, based on the first model, on the first image data;
receiving second image data being same in a pixel number and a recognition target for the inference process as the first image data from a fixed device that photographs the second image data from a fixed position; and
when determining that two pieces of the second image data received from the fixed device continuously in time series have no difference from each other under a state where a failure of the first server is detected, transmitting the first image data to a second server that executes an inference process, based on a second model, on the second image data.

9. The computer-implemented method according to claim 8, wherein
the first server belongs to a server group including servers that each execute, using the first mode, the inference process on the first image data, and
the computer-implemented method further comprises:
instructing a third server being different from the first sever and belonging to the server group to switch the first model to a third model that takes a shorter inference process time than the first model; and
transmitting the first image data to the third server.

10. The computer-implemented method according to claim 9, wherein the second model takes a shorter inference process time than the first model and a longer inference process time than the third model.

11. The computer-implemented method according to claim 9, wherein the transmitting the first image data to the second server comprises:
registering the first image data into a queue; and
when determining that the two pieces of second image data have no difference within a tolerance time based on a registering timing of the first image data into the queue, an upper limit of an inference process time on the first image data, and an inference process time on the first image data by the second server using the second model, transmitting the first image data registered in the queue to the second server.

12. The computer-implemented method according to claim 11, wherein the transmitting the first image data to the second server comprises:
under a presence of a preceding inference process including one or the both of an inference process that the second processor is executing and an inference process that is waiting for being processed by the second server,
when determining that the two pieces of second image data have no difference within the tolerance time based on a scheduled timing of completion of the preceding inference process in addition to the registering timing of the first image data into the queue, the upper limit of an inference process time on the first image data, and the inference process time on the first image data by the second server using the second model, transmitting the first image data registered in the queue to the second server.

13. The computer-implemented method according to claim 11, further comprising:
removing the first image data from the queue after the tolerance time elapses.

14. The computer-implemented method according to claim 9, further comprising:
determining, as an inference result to be transmitted to a destination, a first inference result of the inference process executed on the first image data by the second server using the second model or a combination of the first inference result and a second inference result of an inference process executed on the first image data by the third server using the third model.

15. An alternate inference system comprising:
a first server that executes an inference process, based on a first model, on first image data transmitted from a mobile device that photographs the first image from a variable position;
a second server that executes an inference process, based on a second model, on second image data being same in a pixel number and a recognition target for the inference process as the first image data from a fixed device that photographs the second image data from a fixed position; and
a computer that receives the first image data from the mobile device, that transmits the first image data to the first server, and that receives the second image data from the fixed device, wherein
the computer comprises
a memory; and
a processor coupled to the memory, the processor being configured to
when determining that two pieces of the second image data received from the fixed device continuously in time series have no difference from each other under a state where a failure of the first server is detected, transmit the first image data to a second server that executes an inference process, based on a second model, on the second image data.

16. The alternate inference system according to claim 15, wherein
the first server belongs to a server group including servers that each execute, using the first mode, the inference process on the first image data,
the alternate inference system further comprises a third server belonging to the server group and being different from the first server, and
the processor is further configured to:
instruct the third server to switch the first model to a third model that takes a shorter inference process time than the first model; and
transmit the first image data to the third server.

17. The alternate inference system according to claim 16, wherein the second model takes a shorter inference process time than the first model and a longer inference process time than the third model.

18. The alternate inference system according to claim 16, wherein
the processor is configured to, in the transmitting the first image data to the second server,
register the first image data into a queue; and
when determining that the two pieces of second image data have no difference within a tolerance time based on a registering timing of the first image data into the queue, an upper limit of an inference process time on the first image data, and an inference process time on the first image data by the second server using the second model, transmit the first image data registered in the queue to the second server.

19. The alternate inference system according to claim 18, wherein
the processor is further configured to, in the transmitting the first image data to the second server,
under a presence of a preceding inference process including one or the both of an inference process that the second processor is executing and an inference process that is waiting for being processed by the second server,
when determining that the two pieces of second image data have no difference within the tolerance time based on a scheduled timing of completion of the preceding inference process in addition to the registering timing of the first image data into the queue, the upper limit of an inference process time on the first image data, and the inference process time on the first image data by the second server using the second model, transmit the first image data registered in the queue to the second server.

20. The alternate inference system according to claim 18, wherein the processor is further configured to remove the first image data from the queue after the tolerance time elapses.
